(19) United States
(12) Patent Application Publication
(10) Pub. No.: US 2007/0211827 A1
(43) Pub. Date: Sep. 13, 2007

(54) Channel Estimation in an Ofdm System With High Doppler Shift

(75) Inventors: Constant Paul Marie Jozef Baggen, Eindhoven (NL); Sri Andari Husen, Eindhoven (NL); Maurice Leonardus Anna Stassen, Eindhoven (NL); Hoi Yip Tsang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,444

(22) PCT Filed: May 23, 2005
(86) PCT No.: PCT/IB05/51667

§ 371 Date: Nov. 21, 2006

(30) Foreign Application Priority Data
May 28, 2004 (EP) 04102372.2

(51) Int. Cl. H04L 27/26

(52) U.S. Cl. 375/316

(57) ABSTRACT

A method of signal processing and a signal processor for a receiver for OFDM encoded digital signals. The OFDM encoded digital signals are transmitted as data symbol sub-carriers in several frequency channels. A subset of said sub carriers is in the form of pilot sub-carriers having a value known to the receiver. A first estimation of channel coefficients (H₀) at said pilot sub-carriers is performed followed by cleaning of the estimated channel coefficients (H₀) at the pilot sub-carriers. Then, a second estimation of channels coefficients (H₁) is performed at the data symbol sub-carriers. The first estimation is performed by dividing received symbols (yₚ) at said pilot sub-carriers by the known pilot symbols (aₚ). the channel frequency response is supposed to vary linearly within one OFDM symbol. Therefore for each symbol and sub-band, a channel frequency response and its derivate are calculated or interpolated.

The present invention relates to a method of processing OFDM encoded digital signals and a corresponding signal processor.

The invention further relates to a receiver and to a mobile device that is arranged to receive OFDM encoded digital signals. The invention also relates to a telecommunication system comprising such mobile device. The method may be used for deriving channel coefficients in a system using OFDM technique with pilot sub-carriers, such as a terrestrial video broadcasting system DVB-T. A mobile device can e.g. be a portable TV, a mobile phone, a personal digital assistant, a portable computer such as a laptop or any combination thereof.

In wireless systems for the transmission of digital information, such as voice and video signals, orthogonal frequency division multiplexing technique (OFDM) has been widely used. OFDM may be used to cope with frequency-selective fading radio channels. Interleaving of data may be used for efficient data recovery and use of data error correction schemes.

OFDM is today used in for example the Digital Audio Broadcasting (DAB) system Eureka 147 and the Terrestrial Digital Video Broadcasting system (DVB-T). DVB-T supports 5-30 Mbps net bit rate, depending on modulation and coding mode, over 8 MHz bandwidth. For the 8 K mode, 6817 sub-carriers (of a total of 8192) are used with a sub-carrier spacing of 1116 Hz. OFDM symbol useful time duration is 896 μs and OFDM guard interval is ¼, ⅛, 1/16 or 1/32 of the time duration.

However, in a mobile environment, such as a car or a train, the channel transfer function as perceived by the receiver varies as a function of time. Such variation of the transfer function within an OFDM symbol may result in inter-carrier interference, ICI, between the OFDM sub-carriers, such as a Doppler broadening of the received signal. The inter-carrier interference increases with increasing vehicle speed and makes reliable detection above a critical speed impossible without countermeasures.

A signal processing method is previously known from WO 02/067525, WO 02/067526 and WO 02/067527, in which a signal a as well as a channel transfer function H and the time derivative thereof H′ of an OFDM symbol are calculated for a specific OFDM symbol under consideration.

Moreover, U.S. Pat. No. 6,654,429 discloses a method for pilot-added channel estimation, wherein pilot symbols are inserted into each data packet at known positions so as to occupy predetermined positions in the time-frequency space. The received signal is subject to a two-dimensional inverse Fourier transform, two-dimensional filtering and a two-dimensional Fourier transform to recover the pilot symbols so as to estimate the channel transfer function.

An object of the present invention is to provide a method for signal processing which is less complex.

Another object of the invention is to provide a method for signal processing for estimation of channel coefficients, which uses a Wiener filtering technique and is efficient.

A further object of the invention is to provide a method of signal processing for an OFDM receiver in which inter-carrier interference ICI is mitigated.

These and other objects are met by a method for processing OFDM encoded digital signals. The OFDM encoded digital signals are transmitted as data symbol sub-carriers in several frequency channels, a subset of said sub-carriers being in the form of pilot sub-carriers having a known value. According to the method of the invention, there is provided the steps of first estimation of channel coefficients (H₀) at said pilot sub-carriers; cleaning said estimated channel coefficients (H₀) at said pilot sub-carriers; estimating the temporal derivative of the channel coefficients (H′) by temporal Wiener filtering, and second estimation of channel coefficients (H₁) at said data symbol sub-carriers. Accordingly, a method is provided which is less complex than previous methods.

The first estimation may be performed by dividing received symbols (yₚ) at said pilot sub-carriers by the known pilot symbols (aₚ). In this way, the channel coefficients are obtained for the pilot channels. The cleaning may be performed by Wiener filtering.

According to another embodiment of the invention, a third estimation of channel coefficients at possible pilot sub-carriers in between said pilot sub-carriers is performed before the second estimation. In this way, the estimations are made stepwise, resulting in better estimations.

The second or third estimations may comprise interpolation. The interpolation may be performed in a frequency direction, for example by using a Wiener filter, specifically a 2-tap Wiener filter, possibly followed by an interpolation in a time direction using multiple OFDM symbols, for example by using Wiener filtering.

Alternatively, the interpolation is performed in a time direction, for example by using Wiener filtering, possibly followed by an interpolation in a frequency direction, for example by using Wiener filtering.

The Wiener filtering may be performed by using a finite impulse transfer function (FIR) filter having pre-computed filter coefficients. The Wiener filter may be a filter having a predetermined length (n) and with an actual observation value (M), which is an off-center value, for example −7 or −3 for an 11-tap filter. The predetermined length (n) of the filter may be 9, 11, 13, 23, 25 or 27. The observation value (M) may be varied from −5 to −10 at a left edge of the OFDM symbol and varied from 0 to −5 at a right edge of the OFDM symbol for performing edge filtering.

The method may further comprise cleaning of said first estimation of channel coefficients (H₀) at said pilot sub-carriers by a temporal Wiener filtering. The cleaning may be performed on a subset of the sub-carriers, for example at pilot positions. The cleaning may be performed by a FIR filter.

In another aspect of the invention, there is provided a signal processor for a receiver for OFDM encoded digital signals, for performing the above-mentioned method steps.

Further objects, features and advantages of the invention will become evident from a reading of the following description of exemplifying embodiments of the invention with reference to the appended drawings, in which:

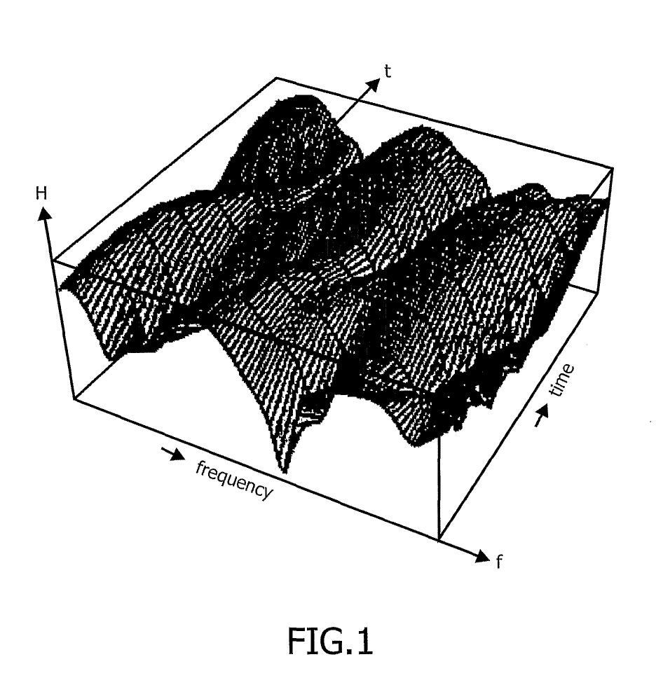

FIG. 1 is a graph showing the channel transfer function as a function of frequency and time;

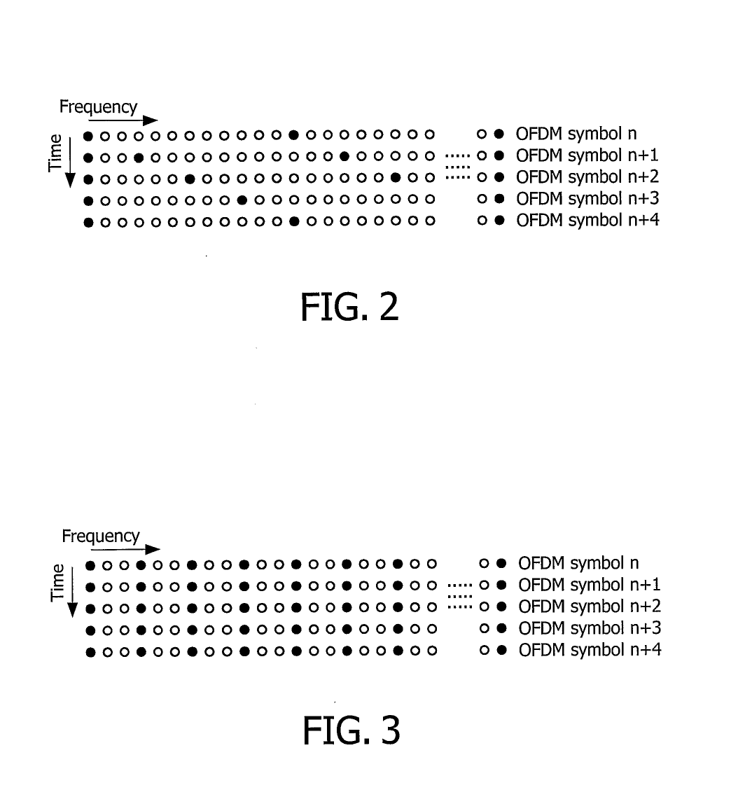

FIG. 2 is a diagram schematically showing OFDM symbols over time and frequency;

FIG. 3 is a diagram similar to FIG. 2 further indicating possible pilot symbol sub-carriers;

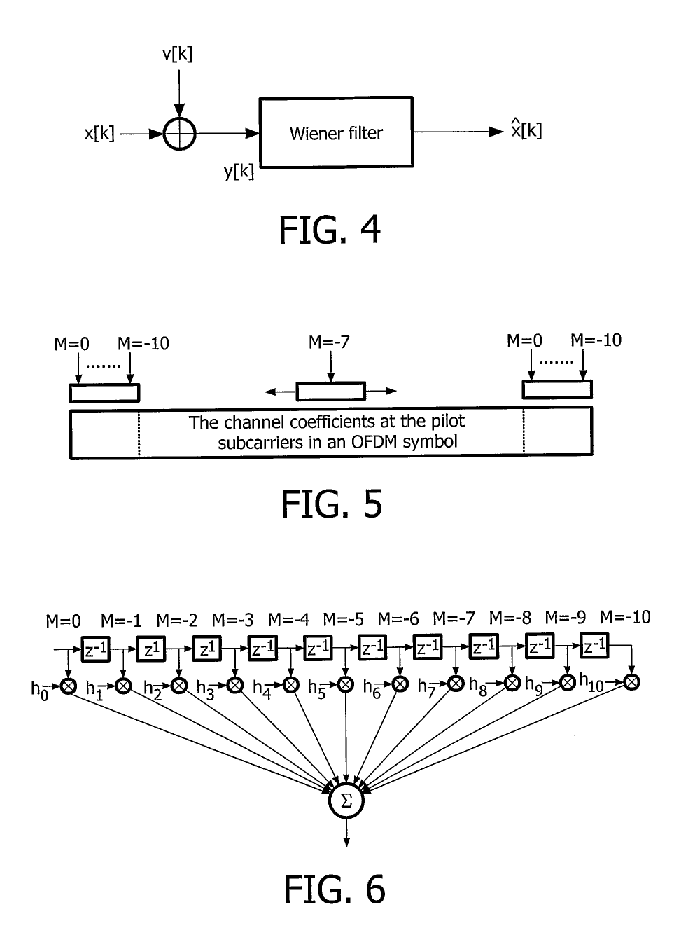

FIG. 4 is a schematic diagram for the calculation of Wiener filter coefficients;

FIG. 5 is a schematic diagram showing how the filter coefficients are filtered;

FIG. 6 is a schematic diagram of an 11-tap Wiener filter.

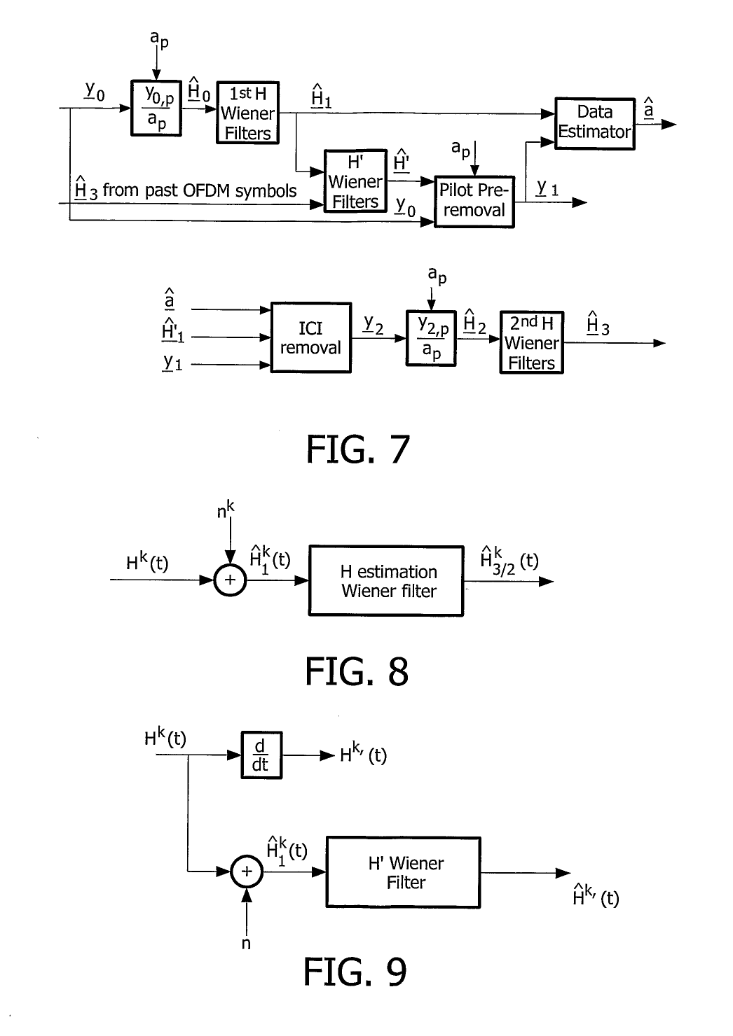

FIG. 7 is a schematic diagram of an overview of the estimation and cancellation scheme according to the invention.

FIG. 8 is a schematic diagram of an H estimation filter.

FIG. 9 is a schematic diagram of an H′ estimation filter.

FIG. 1 is a graph showing variation of the sub-carrier channel transfer function H(f) as perceived by the receiver as a function of time in a mobile environment. The variation of H(f) within an OFDM symbol results in inter-carrier interference, ICI, between the OFDM sub-carriers, so-called Doppler broadening of the received signal.

In Terrestrial Digital Video Broadcast (DVB-T), Orthogonal Frequency Division Multiplex (OFDM) is used for transmitting digital information via a frequency-selective broadcast channel.

If all objects such as the transmitter, the receiver and other scattering objects are stationary, the usage of OFDM having a guard interval of proper length containing a cyclic prefix leads to orthogonal sub-carriers, i.e., simultaneous demodulation of all sub-carriers using an FFT results in no inter-carrier interference. If objects are moving so fast that the chamiel cannot be regarded anymore as being stationary during an OFDM symbol time, the orthogonality between sub-carriers is lost and the received signal is corrupted by ICI, i.e., the signal used to modulate a particular sub-carrier also disturbs other sub-carriers after demodulation. In the frequency domain, such Doppler broadening of a frequency selective Rayleigh fading channel can be understood as if the frequency response H(f) of the channel is evolving as a function of time, but quite independently for frequencies that are farther apart than the coherence bandwidth. It turns out that for an OFDM system using an 8 k FFT the afore-mentioned ICI levels exclude the usage of 64-QAM already at low vehicle speed.

In the present invention, Wiener filtering is used for exploiting the spectral and temporal correlation that exists within and between OFDM symbols for estimation of H(f) and H′(f).

A linear mobile multipath propagation channel is assumed consisting of uncorrelated paths, each of which has a complex attenuation hₗ, a delay τₗ, and a uniformly distributed angle of arrival θₗ. The complex attenuation hₗ is a circular Gaussian random variable with zero mean value. The channel impulse response has an exponentially decaying power profile and is characterized by a root mean square delay spread τᵣₘₛ. It is further assumed that the receiver moves with a certain speed ν resulting in each path having a Doppler shift fₗ=f_{d} cos θₗ so that the complex attenuation of path l at time t becomes hₗ(t)=hₗexp(j2πfₗt). The maximum Doppler shift f_{d} relates to the vehicle speed as f_{d}=f_{c}(ν/c) (assuming this to be the same for all sub-carriers), where c=3·10⁸ m/s, and f_{c} is the carrier frequency.

In an OFDM system, N “QAM-type” symbols (In a DVB-T system, N is 2048 or 8192), denoted as s=[s₀, . . . ,s_{N-1}]^{T}, are modulated onto Northogonal sub-carriers by means of an N-point IFFT to form an OFDM symbol with duration Tᵤ. The symbol is further extended with a cyclic prefix and subsequently transmitted. The transmitted signal goes through the time-varying selective fading channel. It is assumed that the cyclic prefix extension is longer than the duration of the channel impulse response so that the received signal is not affected by intersymbol interference. At the receiver side, the received signal is sampled at rate 1/T (where T=Tᵤ/N) and the cyclic prefix is removed. Next, an N-point FFT is used to simultaneously demodulate all sub-carriers of the composite signal.

The baseband received signal in time domain is denoted as r(t) and expressed as follows:

$$r ( t ) = {\sum }_{n = 0}^{N - 1} {H}_{n} ( t ) {ⅇ}^{j2π n {f}_{s} {t}_{{s}_{n}}} + v ( t ) , \\ {H}_{n} ( t ) = {\sum }_{l} {h}_{l} ( t ) {ⅇ}^{- j2π {nf}_{s} {τ}_{t}} , \qquad ( 1 )$$

where Hₙ(t) is the channel frequency response of sub-carrier n at time t, fₛ=1/Tᵤ is the sub-carrier spacing and ν(t) is AWGN having a two-sided spectral density of N₀/2.

The Taylor expansion of Hₙ(t) is taken around t₀ and approximated up to the first-order term:
Hᵤ(t)=Hₙ(t₀)+H′ₙ(t₀)(t₀−t₀)+O((t−t₀)²). (2)

Using equations (1) and (2), after undergoing the sampling operation and the FFT, the received signal at the m-th sub-carrier, yₘ, can be approximated as follows:

$${y}_{m} \approx \frac{1}{N} {\sum }_{k = 0}^{N - 1} {\sum }_{n = 0}^{N - 1} {H}_{n} ( {t}_{0} ) {ⅇ}^{j2π {f}_{s} ( n - m ) kT} {s}_{n} + \frac{1}{N} {\sum }_{k = 0}^{N - 1} {\sum }_{n = 0}^{N - 1} {H}_{n}^{′} ( {t}_{0} ) ( kT - {t}_{0} ) {ⅇ}^{j2π {f}_{s} ( n - m ) kT} {s}_{n} + {v}_{m} , \qquad ( 3 )$$

where νₘ is the m-th noise sample after the FFT. Substituting T=1/(Nfₛ) and using equation (3) can be rewritten as follows:

$$\frac{1}{N} {\sum }_{k = 0}^{N - 1} {ⅇ}^{j2π ( n - m ) k / N} = δ ( n - m ) . \\ {y}_{m} \approx {H}_{m} ( {t}_{0} ) {s}_{m} + {\sum }_{n = 0}^{N - 1} {H}_{n}^{′} ( {t}_{0} ) {Ξ}_{m , n} {s}_{n} + {n}_{m} . \qquad ( 4 )$$

where t₀=ΔT. In matrix notation, the following approximation is used for the channel model:
y≈Hs+ΞH′s+n, (6)
where H=diag(H₀(t₀), . . . ,H_{N-1}(t₀)) and H′=diag(H′₀(t₀), . . . ,H′_{N-1}(t₀)). t₀ is chosen so that the error of the channel approximation is the smallest, i.e., in the middle of the useful part of an OFDM symbol.

The first term in equation (6) is equivalent to the distorted wanted signal in the static environment where there is no movement. The corresponding channel frequency response H has the following second order statistics in time and frequency:

$$\begin{matrix}E [ {H}_{m} ( {t}_{0} ) {H}_{n}^{*} ( {t}_{0} ) ] = \frac{1}{1 + {j2πτ}_{rms} ( m - n ) {f}_{s}} , & ( 7 ) \\ E [ {H}_{m} ( t + τ ) {H}_{m}^{*} ( t ) ] = {J}_{0} ( 2 π {f}_{d} τ ) . & ( 8 )\end{matrix}$$

where Jₙ is the Bessel function of the first kind of order n. The ICI described in the second term of equation (6) is the result of the spreading of the symbols transmitted at all other sub-carriers by the fixed spreading matrix Ξ weighted by the derivatives H′ₘ. Since Ξ is a fixed matrix, the channel model is fully characterized by Hₘ and H′ₘ. Knowledge of this structure is advantageous for channel estimation, as the number of parameters to be estimated is 2N rather than N².

Equation (6) also forms the basis of the ICI suppression scheme as first the ICI is approximated using estimates of H′ and s, followed by subtracting it from the received signal y.

Linear Minimum Mean Square Error (MMSE) estimates of the channel parameters (Hₘ and H′ₘ) and the transmitted data are obtained by applying discrete-time or discrete-frequency Wiener filtering. Suppose that a set of noisy observations yₖ, k ε {1, . . . ,L} is available from which a random variable xₗ is to be estimated. A linear MMSE estimate of xₗ is obtained by using an L-tap FIR filter:

$${\hat{x}}_{l} = {\sum }_{k = 1}^{L} {α}_{k} {y}_{k} , \qquad ( 9 )$$

where minimization of the Mean Square Error requires that αk satisfy the so-called Normal Equations:

$$E [ {x}_{l} {y}_{m}^{*} ] = {\sum }_{k = 0}^{L} {α}_{k} E [ {y}_{k} {y}_{m}^{*} ] , m ∈ \{ 1 , … , L \} . \qquad ( 10 )$$

It can then be shown that the Mean Square Error (MSE) of the estimation using these filter coefficients equals MSE=E[|xₗ|²]−E[|xˆₗ|²].

The matrix H is estimated per OFDM symbol basis by using the regular structure of the scattered pilots in the OFDM symbols as defined by the DVB-T standard. The pilot symbols provide noisy initial estimates of H at the pilot positions, where the noise consists both of AWGN and the ICI caused by Doppler spread. A Wiener filter is applied in the frequency domain for obtaining MMSE estimates of H at the pilot symbols, exploiting the spectral correlation of H. Next, these results are interpolated to obtain H at the remaining data sub-carriers in between the pilot sub-carriers.

The approach is to estimate H′ₘ using the temporal correlation of Hₘ as given in equation (8). It can be shown that the random process H′ₘ(t) exists because R_{HH}(t) is band-limited, where R_{HH}(t) stands for the temporal correlation of H at a fixed frequency. Given a set of noisy measurements y(t)=Hₘ(t)+n(t) from a number of consecutive OFDM symbols, a temporal Wiener filter can be designed that provides MMSE estimates of H′ₘ(t) using these noisy measurements, if the second order statistics E[y(t)y*(s)] and E[H′ₘ(t) y*(s)] are known. Using the independence between noise and H and Equation (8), equation (11) is obtained:
E[y(t)y*(s)]=J₀(2πf_{d}(t−s))+σₙ²δ(t−s). (11)
Similarly, equation (12) is obtained:

$$\begin{matrix}E [ {H}_{m}^{′} ( t ) {y}^{*} ( s ) ] = E [ {H}_{m}^{′} ( t ) ( {H}_{m}^{*} ( s ) + {n}_{m}^{*} ( s ) ) ] \\ = E [ {H}_{m}^{′} ( t ) {H}_{m}^{*} ( s ) ] \\ = E [ \{ l . i . {m}_{ɛ \to 0} \frac{{H}_{m} ( t + ɛ ) - {H}_{m} ( t )}{ɛ} \} {H}_{m}^{*} ( s ) ] \\ = {lim}_{ɛ \to 0} \frac{E [ {H}_{m} ( t + ɛ ) {H}_{m}^{*} ( s ) ] - E [ {H}_{m} ( t ) {H}_{m}^{*} ( s ) ]}{ɛ} \\ = \frac{\partial }{\partial t} {R}_{HH} ( t , s ) \\ = - 2 π {f}_{d} {J}_{1} ( 2 π {f}_{d} ( t - s ) ) ,\end{matrix} \qquad ( 12 )$$

where l.i.m. stands for “limit in the mean”. Using these correlation functions, Wiener filters are obtained that estimate H′ₘ(t) in the middle of an OFDM symbol using noisy estimates of Hₘ(t) from the surrounding OFDM symbols. Actually, the temporal Wiener filter may be used only for an equally spaced subset of sub-carriers called virtual pilot sub-carriers. At the remaining sub-carriers H′ₘ may be obtained by interpolation in the frequency domain exploiting the spectral correlation of H′ₘ, which turns out to be the same as that of Hₘ (Equation (7)).

Finally, R_{H′H′}(0) is needed, the power of the WSS derivative process for the performance evaluation of the Wiener filters for H′ₘ:

$$\begin{matrix}{R}_{{H}^{′} {H}^{′}} ( 0 ) = - {lim}_{τ \to 0} {( \frac{ⅆ}{ⅆ τ} )}^{2} {R}_{HH} ( τ ) \\ = - {lim}_{τ \to 0} {( \frac{ⅆ}{ⅆ τ} )}^{2} {J}_{0} ( 2 π {f}_{d} \cdot τ ) \\ = \frac{{( 2 π {f}_{d} )}^{2}}{2} .\end{matrix} \qquad ( 13 )$$

The data estimation is performed per sub-carrier using standard MMSE equalizers. If a low-complexity solution is desired, one-tap MMSE equalizers may be chosen. Using the derivation as given above, the estimated symbol at sub-carrier m is given as follows:

$${\hat{s}}_{m} = \frac{{\hat{H}}_{m}^{*}}{{\vert {H}_{m} \vert}^{2} + {σ}_{ICI , m}^{2} + {σ}_{\hat{H}}^{2} + {N}_{0}} {y}_{m} , \\ where \\ {σ}_{ICI , m}^{2} = {\sum }_{n = 0}^{N - 1} {\vert {Ξ}_{m , n} \vert}^{2} {\vert {H}_{n}^{′} \vert}^{2} E \vert {s}_{n} {s}_{n}^{*} \vert \qquad ( 14 )$$

is the ICI power at sub-carrier m and σ²_{ˆH} is the MSE of H estimation.

Since the ratio of the signal power to the interference plus noise power (SINR) of the received signal is low in a high-speed environment due to the ICI, the estimated data might not have sufficient quality for symbol detection. However, the soft-estimated data can still be used for regenerating the ICI sufficiently accurately to be used for canceling it largely from the received signal. Because of the ICI removal operation, the SINR improves and therefore better estimated data can be obtained by performing data re-estimation. However, as the SINR increases, the MSE of Hₘ needs also to be lower, so that the inaccuracy in the estimated Hₘ does not become a dominant source of error in data re-estimation process. Therefore a re-estimation of H is also performed.

The present invention involves the estimation of time varying channels using frequency domain Wiener filtering. This invention is used to combat the Doppler effect in mobile reception of DVB-T signals, which is an OFDM based system. It can be shown that the received signal will have the following form:
y≈(diag{H}+Ξ·diag{H′})·a+n
where y is received signal vector, H is the complex transfer function of the channel at all sub-carriers, H′ is the temporal derivative of H, Ξ is the ICI-spreading matrix, a is the transmitted vector and n is a complex circular white Gaussian noise vector. With channel estimation is meant here the estimation of the transfer function H and the temporal derivative H′.

A list of used channel models encountered in prior art is given below:

Wide Sense Stationary Uncorrelated Scattering (WSSUS) channel model:

$$H ( f , t ) = \frac{1}{\sqrt{M}} {\sum }_{i = 1}^{M} {ⅇ}^{j ( {φ}_{i} + 2 π {f}_{{D}_{i}} t - 2 π f {τ}_{i} )}$$

With φᵢ the phase, f_{Di} the Doppler frequency and τᵢ the delay of the ith path. M denotes the number of propagation paths. φᵢ, f_{Di} and τᵢ are random variables, which are independent of each other.

Mobile wireless channel

$$c ( t , τ ) = {\sum }_{m} {γ}_{m} ( t ) δ ( τ - {τ}_{m} ( t ) ) ,$$

with τₘ(t) and γₘ(t) the delay and complex amplitude of the mth path, respectively. Power profile is exponentially decaying.

Mobile multipath channel based on COST-207 (Commission of the European Communities, COST 207: Digital Land Mobile Radio Communications. Luxembourg: Final Report, Office for Official Publications of the European Communities, 1989.)

The channel model used throughout this invention disclosure is explained in the following. The power profile of the used channel is exponentially decaying. It causes the receiver to see L reflections of the transmitted signal with each reflection having its own delay, τₗ, complex attenuation hₗ and Doppler shift fₗ. A description of these parameters is given next.

Delay τₗ: τₗ is a uniformly distributed random variable between 0 and τₘₐₓ, where τₘₐₓ is the maximum delay spread.

Complex attenuation hₗ: The attenuation hₗ is described as follows:

$${h}_{l} = {Ab}_{l} exp ( \frac{- {τ}_{l}}{2 {τ}_{rms}} ) , with {τ}_{l} = 0 , \frac{1}{L} {τ}_{max} , … , \frac{L - 1}{L} {τ}_{max}$$

τₘₐₓ is the maximum delay spread
bₗ is a complex circular Gaussian random variable with mean 0 and a variance of 1.
A is chosen such that

$${\sum }_{l = 0}^{L - 1} E [ {\vert {h}_{l} \vert}^{2} ] = 1$$

Derivation of A

$$\begin{matrix}{\sum }_{l = 0}^{L - 1} E [ {\vert {h}_{l} \vert}^{2} ] = {\sum }_{l = 0}^{L - 1} E [ {\vert {Ab}_{l} exp ( \frac{- τ}{2 {τ}_{rms}} ) \vert}^{2} ] \\ = {\sum }_{l = 0}^{L - 1} {\vert A \vert}^{2} E [ {\vert {b}_{l} \vert}^{2} ] E [ {\vert exp ( \frac{- τ}{2 {τ}_{rms}} ) \vert}^{2} ] \\ = {\vert A \vert}^{2} {\sum }_{l = 0}^{L - 1} E [ {\vert exp ( \frac{- τ}{2 {τ}_{rms}} ) \vert}^{2} ] , Note \text{:} E [ f ( x ) ] = {\sum }_{x} f ( x ) P ( x ) \\ = {\vert A \vert}^{2} {\sum }_{l = 0}^{L - 1} ( {\sum }_{l = 0}^{L - 1} exp ( \frac{- {τ}_{l}}{{τ}_{rms}} ) \frac{1}{L} ) \\ = {\vert A \vert}^{2} {\sum }_{l = 0}^{L - 1} exp ( \frac{- {τ}_{l}}{{τ}_{rms}} ) \\ = 1\end{matrix} This gives \text{:} \vert A \vert = \frac{1}{\sqrt{{\sum }_{l = 0}^{L - 1} exp ( \frac{- {τ}_{l}}{{τ}_{rms}} )}}$$

τᵣₘₛ is the RMS delay spread.
Doppler shift fₗ: The Doppler shift is related to the angle of arrival θₗ, i.e. the angle between the incoming electromagnetic wave and the receiving antenna. θₗ is assumed to be a uniformly distributed random variable between −π and π. The relation between fₗ and θₗ is as follows: fₗ=F_{d} cos(θₗ).

$${F}_{d} = \frac{{v}_{Rx} {f}_{c}}{c}$$

is the maximum Doppler shift based on the speed of the receiver, ν_{Rx}, the carrier frequency, f_{c}, and the speed of light, c.

A particular realization of the channel is described mathematically as follows:

$$h ( n , l ) = {Ab}_{l} exp ( \frac{- {τ}_{l}}{2 {τ}_{rms}} ) exp ( j2π {f}_{l} nT )$$

with T the sampling period,

$${τ}_{l} = l \frac{{τ}_{max}}{L}$$

the delay of path l (Note: τₘₐₓ is chosen to be a integer multiple of the sampling period T, i.e. τₘₐₓ=cT, with c an integer), l=0 . . . L-1 the path index and n=0, 1, 2, . . . the time index.

In the prior art, normally the channel is kept constant in the time domain, during one entire OFDM symbol, which is not required in the present invention.

According to the present invention, complex linear interpolation/filtering is used.

According to the present invention, it is preferred to first filter and interpolate in the frequency domain and then do the same in the time domain. The reason is that the channel may change very fast in the time domain, which makes the filtering and interpolation very difficult.

In the present invention, the interpolation/filtering is done stepwise, i.e. first the active pilot sub-carriers, next the possible pilot sub-carriers and finally the data sub-carriers. The advantage of this approach is that the interpolation filters, for obtaining the channel coefficients at the possible pilot sub-carriers and the data sub-carriers, can have much shorter filter lengths and they still provide the same accuracy.

At the edges a-symmetric Wiener filtering is performed in the present invention.

At the edges non-uniform noise loading is applied in the present invention, because the noise power at the edge is half the “normal” noise power of a sub-carrier in the middle of an OFDM symbol, because the ICI is either only coming from the left sub-carriers either only from the right ones.

It can be shown that the auto-correlation function of H in the frequency domain has the following form:

$${R}_{HH} ( Δ f ) = \frac{1}{1 + j2π Δ f \frac{{τ}_{rms}}{N}}$$

Δf is in multiples of

$$\frac{1}{{NT}_{s}} ,$$

with Tₛ the sampling period and N the total number of sub-carriers, τᵣₘₛ is the RMS delay spread normalized to the Tₛ.

It can be shown that the auto-correlation function of H′ in the frequency domain has the following form:

$${R}_{{H}^{′} {H}^{′}} ( Δ f ) = \frac{1}{1 + j2π Δ f \frac{{τ}_{rms}}{N}}$$

The invention involves estimation of the frequency response of a time varying channel using Wiener filtering in the frequency and possibly the time domain. The estimation of the time varying channel consists of the following steps.

1. Compute a first estimation of the channel coefficients at the pilot sub-carriers by dividing the received symbols at the pilot sub-carriers by the known pilot symbols.

2. Cleaning the channel coefficients at the pilot sub-carriers, the first estimation of the channel coefficients at the pilot positions is cleaned by filtering these channel coefficients using a Wiener filter, which is explained later.

3. Channel estimation at P number of sub-carriers between 2 pilot sub-carriers using interpolation. This can be performed in several ways, which are a combination of time and frequency processing. They are enlisted below.

a. Using the cleaned channel coefficients at the pilot sub-carriers in one OFDM symbol, the n channel coefficients between 2 pilot sub-carriers are interpolated, in the frequency direction, using a (2-tap) Wiener filter.

b. Using the cleaned channel coefficients at the pilot sub-carriers in one OFDM symbol, the n channel coefficients between 2 pilot sub-carriers are interpolated, in the frequency direction, using a (2-tap) Wiener filter. Next clean the n interpolated channel coefficients by filtering them, using a Wiener filter, in the time direction.

c. Using the cleaned channel coefficients at the pilot sub-carriers in multiple OFDM symbols, the n channel coefficients between 2 pilot sub-carriers are interpolated, in the time direction, using a Wiener filter.

d. Using the cleaned channel coefficients at the pilot sub-carriers in multiple OFDM symbols, the n channel coefficients between 2 pilot sub-carriers are interpolated, in the time direction, using a Wiener filter. Next clean the n interpolated channel coefficients by filtering them, using a Wiener filter, in the frequency direction.

The preferred embodiment are steps a. or b., because the channel is changing too fast, which makes filtering in the time domain first not effective. Furthermore, the n channel coefficients are preferably the 3 possible pilot sub-carriers between 2 pilot sub-carriers. Step c. or d. can be done if the Doppler frequencies are sufficiently low.

4. Channel estimation at the remaining sub-carriers using interpolation, using the cleaned channel coefficients at the pilot sub-carriers and the P interpolated channel coefficients between the pilot sub-carriers in one OFDM symbol, the remaining channel coefficients are interpolated, in the frequency direction, using a (2-tap) Wiener filter.

The preferred embodiment are that data sub-carriers are interpolated using a (2-tap) Wiener filter.

In the following is shown how the Wiener coefficients, which are necessary for the filtering and interpolation operations, are obtained. The used model to calculate the Wiener filter coefficients is depicted in FIG. 4, where x[k] is the originally transmitted signal at index k, ν[k] is the noise signal at index k (ν[k] is composed of two components, namely the inter-carrier interference and additive noise, but here it is not necessary to make this distinction), y[k] is the noise corrupted signal, which is going to be filtered by the Wiener filter, and \hat{x}[k] is the output of the Wiener filter.

Furthermore the following things hold or are assumed:

$$y [ k ] = x [ k ] + v [ k ]$$

$$Error = ɛ [ k ] = \hat{x} [ k ] - x [ k ]$$

$$\hat{x} [ k + M ] = {\sum }_{n = 0}^{{n}_{1}} w [ n ] y [ k - n ]$$

M is a parameter that gives which at which time instant \hat{x} is being estimated when y[k] is supplied to the Wiener filter (M≦0→interpolation or filtering and M>0 →prediction)

x[i] and v[j] are uncorrelated for all i and j, i.e. E[x[i]v*[j]]=0 ∀i, j

ε[i] and y[j] are orthogonal to each other (the orthogonality principle), i.e. E[ε[i]y*[j]]=0 ∀i, j

The filter coefficients of the Wiener filter, w[n], are chosen such that the mean square error (MSE), i.e. E[|ε|²], is minimized. The derivation for obtaining the Wiener filter coefficients that minimize the MSE is shown below. Start with the orthogonality principle:

$$\begin{matrix}E [ ɛ [ k + M ] {y}^{*} [ k - m ] ] = 0 & m ∈ [ 0 , {n}_{1} ]\end{matrix}$$

$$E [ ( \hat{x} [ k + M ] - x [ k + M ] ) {y}^{*} [ k - m ] ] = 0$$

$$E [ x [ k + M ] {y}^{*} [ k - m ] ] = {\sum }_{n = 0}^{{n}_{1}} w [ n ] E [ y [ k - n ] {y}^{*} [ k - m ] ]$$

$$E [ x [ k + M ] {x}^{*} [ k - m ] ] + E [ x [ k + M ] {v}^{*} [ k - m ] ] = {\sum }_{n = 0}^{{n}_{1}} w [ n ] \{ E [ x [ k - n ] {x}^{*} [ k - m ] ] + E [ x [ k - n ] {v}^{*} [ k - m ] ] + E [ v [ k - n ] {x}^{*} [ k - m ] ] + E [ v [ k - n ] {v}^{*} [ k - m ] ] \}$$

$$E [ x [ k + M ] {x}^{*} [ k - m ] ] = {\sum }_{n = 0}^{{n}_{1}} w [ n ] \{ E [ x [ k - n ] {x}^{*} [ k - m ] ] + E [ v [ k - n ] {v}^{*} [ k - m ] ] \}$$

$${R}_{xx} [ m + M ] = {\sum }_{n = 0}^{{n}_{1}} w [ n ] \{ {R}_{xx} [ m - n ] + {R}_{vv} [ m - n ] \}$$

This can be written as a matrix-vector multiplication:

$$\begin{matrix}[ \begin{matrix}{R}_{xx} [ M ] \\ {R}_{xx} [ M + 1 ] \\ ⋮ \\ {R}_{xx} [ M + {n}_{1} ]\end{matrix} ] = \{ \begin{matrix}[ \begin{matrix}{R}_{xx} [ 0 ] & {R}_{xx} [ - 1 ] & ⋯ & {R}_{xx} [ - {n}_{1} ] \\ {R}_{xx} [ 1 ] & {R}_{xx} [ 0 ] & ⋯ & {R}_{xx} [ - {n}_{1} + 1 ] \\ ⋮ & ⋮ & ⋰ & ⋮ \\ {R}_{xx} [ {n}_{1} ] & {R}_{xx} [ {n}_{1} - 1 ] & ⋯ & {R}_{xx} [ 0 ]\end{matrix} ] + \\ [ \begin{matrix}{R}_{vv} [ 0 ] & {R}_{vv} [ - 1 ] & ⋯ & {R}_{vv} [ - {n}_{1} ] \\ {R}_{vv} [ 1 ] & {R}_{vv} [ 0 ] & ⋯ & {R}_{vv} [ - {n}_{1} + 1 ] \\ ⋮ & ⋮ & ⋰ & ⋮ \\ {R}_{vv} [ {n}_{1} ] & {R}_{vv} [ {n}_{1} - 1 ] & ⋯ & {R}_{vv} [ 0 ]\end{matrix} ]\end{matrix} \} \\ [ \begin{matrix}w [ 0 ] \\ w [ 1 ] \\ ⋮ \\ w [ {n}_{1} ]\end{matrix} ]\end{matrix}$$

$${r}_{xx}^{M} = ( {R}_{xx} + {R}_{vv} ) w$$

$$w = {( {R}_{xx} + {R}_{vv} )}^{- 1} {r}_{xx}^{M}$$

NOTE: from the above it may seem that the observations y are coming from a grid where the observations are spaced equidistantly. This is not always the case. For example OFDM symbol n+1 in FIG. 2 has at the left edge two pilot sub-carriers that are 3 sub-carriers apart, at the right edge 2 sub-carriers that are 9 sub-carriers apart (this is not shown in the figure) and all the other pilot sub-carriers are 12 sub-carriers apart. This non-equidistant spacing has to be taken into account for the calculation of the Wiener filter coefficients.

The resulting minimum mean square error is the following:

$$\begin{matrix}MMSE = E [ {\vert ɛ [ k + M ] \vert}^{2} ] \\ = E [ ɛ [ k + M ] ( {\hat{x}}^{*} [ k + M ] - {x}^{*} [ k + M ] ) ] \\ = E [ ɛ [ k + M ] {\hat{x}}^{*} [ k + M ] ] - E [ ɛ [ k + M ] {x}^{*} [ k + M ] ] \\ = {\sum }_{n = 0}^{{n}_{1}} {w}^{*} [ n ] E [ ɛ [ k + M ] {y}^{*} [ k - n ] ] - E [ ɛ [ k + M ] {x}^{*} [ k + M ] ] \\ = E [ ( x [ k + M ] - \hat{x} [ k + M ] ) {x}^{*} [ k + M ] ] \\ = E [ x [ k + M ] {x}^{*} [ k + M ] ] - E [ \hat{x} [ k + M ] {x}^{*} [ k + M ] ] \\ = E [ x [ k + M ] {x}^{*} [ k + M ] ] - {\sum }_{n = 0}^{{n}_{1}} w [ n ] E [ y [ k - n ] {x}^{*} [ k + M ] ] \\ = E [ x [ k + M ] {x}^{*} [ k + M ] ] - {\sum }_{n = 0}^{{n}_{1}} w [ n ] E [ \begin{matrix}( \begin{matrix}x [ k - n ] + \\ v [ k - n ]\end{matrix} ) \\ {x}^{*} [ k + M ]\end{matrix} ] \\ = E [ x [ k + M ] {x}^{*} [ k + M ] ] - {\sum }_{n = 0}^{{n}_{1}} w [ n ] E [ x [ k - n ] {x}^{*} [ k + M ] ] \\ = {R}_{xx} [ 0 ] - {\sum }_{n = 0}^{{n}_{1}} w [ n ] {R}_{xx} [ - n - M ] \\ = {R}_{xx} [ 0 ] - {\sum }_{n = 0}^{{n}_{1}} w [ n ] {R}_{xx}^{*} [ n + M ] \\ = {R}_{xx} [ 0 ] - {( {r}_{xx}^{M} )}^{H} w \\ = {R}_{xx} [ 0 ] - {( {r}_{xx}^{M} )}^{H} {( {R}_{xx} + {R}_{vv} )}^{- 1} {r}_{xx}^{M}\end{matrix}$$

During the normal working of a Wiener filter an observation y[k] shifts into the Wiener filter and \hat{x}[k+M], where M is a fixed value, is calculated using the optimum Wiener filter coefficients, see also FIG. 5. This can also be visualized as if the Wiener filter is sliding over the to be filtered channel coefficients, say from left to right in FIG. 5. One can see that when the Wiener filter is sliding into the channel coefficients from the left edge that the Wiener filter will be partially filled, the same holds when the Wiener filter is sliding out of the channel coefficients at the right edge. This is undesired, because one wants as many channel coefficients as possible to perform the filtering operation. To solve this the Wiener filter is placed exactly at the edge, see FIG. 5. Now by setting the parameter M to the correct value, interpolated or filtered versions of \hat{x}[k+M] at the edge sub-carriers can be obtained. This makes the Wiener filters become a-symmetrical filters.

Once the length of the Wiener filter is decided upon, the value of the parameter M needs to be fixed. From literature it is known that setting M=0 or M=−n₁ the MSE is largest, i.e. only past or future observations are used to do the estimations.
If

$$M = - ⌊ \frac{{n}_{1}}{2} ⌋ ,$$

with └x┘ the floor operation, the MSE is smallest, i.e. using as many past as future observations.

But because the pilot sub-carriers are spaced 12 sub-carriers apart (this is stated by the DVB-T standard), the auto-correlation function R_{HH} needs to be sub-sampled accordingly. This makes that MSE is minimum when M is set to an off-center value. For n₁=10 (an 11-taps Wiener filter), MSE is minimum when M=−7 or M=−3. This holds for the following lengths of the Wiener filter, lengths: 9, 11, 13, 23, 25 and 27 taps.

For deriving the optimal Wiener filter coefficients, besides that the statistics of the channel coefficients is needed, the statistics of the noise signal is also needed. We assume that the noise, which is composed of an inter-carrier interference component and an additive noise component, is just additive and white. We have two kinds of noise loading: uniform noise loading and non-uniform noise loading.

Uniform noise loading is used when the channel coefficients in the “middle part” of an OFDM symbol are estimated. Here we make the extra assumption that the noise is also a Wide Sense Stationary, WSS, process.

Non-uniform noise loading is used when we are performing edge filtering. The reason to use another noise loading than uniform is that the sub-carriers at the left edge of an OFDM symbol experience inter-carrier interference only from the right neighboring sub-carriers. At the right edge the interference is coming only from the left neighboring sub-carriers. This makes that the noise power present at the most left and most right channel coefficient is 3 dB less than the power present at the other channel coefficients. Because of this non-uniformity of the noise power, the noise is treated as a non-WSS process.

In the example given below all Wiener filters are derived, which are needed to estimate the frequency response of the channel. Furthermore we assume that we have received an OFDM symbol with the pilot sub-carriers arranged as in OFDM symbol n as shown in FIG. 2. For a preferred embodiment we use the following parameters:

The Wiener filters for cleaning the channel coefficients at the pilot sub-carriers and the edge filters have length of 11-taps, see FIG. 6, i.e. n₁=10

The filters for interpolating channel coefficients at the possible pilot sub-carriers and the data sub-carriers have length 2, i.e. n₁=1

M=−7 for estimating the channel coefficients in the middle of an OFDM symbol

For the edge filtering, M is varied from −5 to −10 at the left edge and from 0 to −5 at the right edge.

For interpolating the coefficients at the possible pilot sub-carriers M is set to the values −3, −6 and −9.

For interpolating the coefficients at the data sub-carriers M is set to −1 and −2.

An OFDM symbol has N=1024 sub-carriers

The RMS delay spread is τᵣₘₛ=1.1428 μs

The noise is white, i.e.

$${R}_{vv} [ i - j ] = E [ {v}_{i} {v}_{j}^{*} ] = \{ \begin{matrix}{σ}^{2} = 0.0089 , if i = j \\ 0 , otherwise\end{matrix}$$

The noise power at the sub-carrier at the leftmost and rightmost edge is E[|υedge|²]=0.0045

$${R}_{HH} [ k ] = \frac{1}{1 + j 2 π k \frac{{τ}_{rms}}{N}} .$$

Maximum Doppler shift=f_{dmax}=0.1·carrier spacing≈112 Hz

Using the equations derived in the above, the filter coefficients for filtering the channel coefficients at the pilot sub-carriers are the following:

$$w = {( {R}_{HH} + {R}_{vv} )}^{- 1} {r}_{HH}^{0}$$

$$\begin{matrix}[ \begin{matrix}w [ 0 ] \\ w [ 1 ] \\ ⋮ \\ w [ 10 ]\end{matrix} ] = {\{ \begin{matrix}[ \begin{matrix}{R}_{HH} [ 0 ] & {R}_{HH} [ - 12 ] & ⋯ & {R}_{HH} [ - 120 ] \\ {R}_{HH} [ 12 ] & {R}_{HH} [ 0 ] & ⋯ & {R}_{HH} [ - 108 ] \\ ⋮ & ⋮ & ⋰ & ⋮ \\ {R}_{HH} [ 120 ] & {R}_{HH} [ 108 ] & ⋯ & {R}_{HH} [ 0 ]\end{matrix} ] + \\ [ \begin{matrix}{R}_{vv} [ 0 ] & {R}_{vv} [ - 12 ] & ⋯ & {R}_{vv} [ - 120 ] \\ {R}_{vv} [ 12 ] & {R}_{vv} [ 0 ] & ⋯ & {R}_{vv} [ - 108 ] \\ ⋮ & ⋮ & ⋰ & ⋮ \\ {R}_{vv} [ 120 ] & {R}_{vv} [ 108 ] & ⋯ & {R}_{vv} [ 0 ]\end{matrix} ]\end{matrix} \}}^{- 1} \\ [ \begin{matrix}{R}_{HH} [ - 84 ] \\ {R}_{HH} [ - 72 ] \\ ⋮ \\ {R}_{HH} [ 36 ]\end{matrix} ]\end{matrix}$$

$$\begin{matrix}[ \begin{matrix}w [ 0 ] \\ w [ 1 ] \\ ⋮ \\ w [ 10 ]\end{matrix} ] = {\{ \begin{matrix}[ \begin{matrix}{R}_{HH} [ 0 ] & {R}_{HH} [ - 12 ] & ⋯ & {R}_{HH} [ - 120 ] \\ {R}_{HH} [ 12 ] & {R}_{HH} [ 0 ] & ⋯ & {R}_{HH} [ - 108 ] \\ ⋮ & ⋮ & ⋰ & ⋮ \\ {R}_{HH} [ 120 ] & {R}_{HH} [ 108 ] & ⋯ & {R}_{HH} [ 0 ]\end{matrix} ] + \\ [ \begin{matrix}{σ}^{2} & 0 & ⋯ & 0 \\ 0 & {σ}^{2} & ⋯ & 0 \\ ⋮ & ⋮ & ⋰ & ⋮ \\ 0 & 0 & ⋯ & {σ}^{2}\end{matrix} ]\end{matrix} \}}^{- 1} \\ [ \begin{matrix}{R}_{HH} [ - 84 ] \\ {R}_{HH} [ - 72 ] \\ ⋮ \\ {R}_{HH} [ 36 ]\end{matrix} ]\end{matrix} \\ [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0037 - 0.0599 i \\ - 0.0005 - 0.0249 i \\ 0.0139 + 0.0127 i \\ 0.0430 + 0.0464 i \\ 0.0853 + 0.0664 i \\ 0.1319 + 0.0645 i \\ 0.1687 + 0.0396 i \\ 0.1821 - 0.0000 i \\ 0.1660 - 0.0377 i \\ 0.1256 - 0.0560 i \\ 0.0759 - 0.0436 i\end{matrix} ]$$

The left edge filters:

$$\begin{matrix}M = - 10 & M = - 9 \\ [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0281 + 0.0236 i \\ - 0.0106 - 0.0013 i \\ - 0.0024 - 0.0242 i \\ - 0.0025 - 0.0400 i \\ - 0.0066 - 0.0433 i \\ - 0.0064 - 0.0306 i \\ 0.0092 - 0.0035 i \\ 0.0507 + 0.0291 i \\ 0.1232 + 0.0519 i \\ 0.2223 + 0.0469 i \\ 0.6657\end{matrix} ] & [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0082 - 0.0116 i \\ 0.0008 - 0.0180 i \\ 0.0029 - 0.0195 i \\ 0.0031 - 0.0119 i \\ 0.0088 + 0.0053 i \\ 0.0271 + 0.0274 i \\ 0.0608 + 0.0455 i \\ 0.1068 + 0.0499 i \\ 0.1560 + 0.0346 i \\ 0.1974 \\ 0.4436 - 0.0935 i\end{matrix} ]\end{matrix}$$

$$\begin{matrix}M = - 8 & M = - 7 \\ [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0002 - 0.0427 i \\ 0.0024 - 0.0279 i \\ 0.0062 - 0.0068 i \\ 0.0174 + 0.0198 i \\ 0.0415 + 0.0461 i \\ 0.0784 + 0.0622 i \\ 0.1203 + 0.0595 i \\ 0.1544 + 0.0363 i \\ 0.1681 + 0.0000 i \\ 0.1560 - 0.0346 i \\ 0.2459 - 0.1035 i\end{matrix} ] & [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0026 - 0.0629 i \\ 0.0003 - 0.0253 i \\ 0.0151 + 0.0144 i \\ 0.0450 + 0.0493 i \\ 0.0877 + 0.0694 i \\ 0.1337 + 0.0666 i \\ 0.1682 + 0.0402 i \\ 0.1770 - 0.0000 i \\ 0.1544 - 0.0363 i \\ 0.1068 - 0.0499 i \\ 0.1012 - 0.0581 i\end{matrix} ]\end{matrix}$$

$$\begin{matrix}M = - 6 & M = - 5 \\ [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0094 - 0.0650 i \\ 0.0038 - 0.0085 i \\ 0.0369 + 0.0390 i \\ 0.0852 + 0.0669 i \\ 0.1369 + 0.0679 i \\ 0.1763 + 0.0421 i \\ 0.1887 + 0.0000 i \\ 0.1682 - 0.0402 i \\ 0.1203 - 0.0595 i \\ 0.0608 - 0.0455 i \\ 0.0183 + 0.0070 i\end{matrix} ] & [ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0088 - 0.0442 i \\ 0.0226 + 0.0182 i \\ 0.0737 + 0.0569 i \\ 0.1301 + 0.0643 i \\ 0.1743 + 0.0415 i \\ 0.1916 + 0.0000 i \\ 0.1763 - 0.0421 i \\ 0.1337 - 0.0666 i \\ 0.0784 - 0.0622 i \\ 0.0271 - 0.0274 i \\ - 0.0128 + 0.0610 i\end{matrix} ]\end{matrix}$$

The right edge filters:

These filters are the same as the left edge filters, only the coefficients have to be reversed in order and complex conjugated. M_{right}=0 is equivalent to M_{left}=−10, M_{right}=−1 is equivalent to M_{left}=−9 etc.

Possible pilot sub-carriers interpolation filters:

$$\begin{matrix}M = - 9 & M = - 6 & M = - 3 \\ [ \begin{matrix}w [ 0 ] \\ w [ 1 ]\end{matrix} ] = [ \begin{matrix}0.4260 + 0.0313 i \\ 0.5688 - 0.0164 i\end{matrix} ] & [ \begin{matrix}w [ 0 ] \\ w [ 1 ]\end{matrix} ] = [ \begin{matrix}0.4975 + 0.0269 i \\ 0.4975 - 0.0269 i\end{matrix} ] & [ \begin{matrix}w [ 0 ] \\ w [ 1 ]\end{matrix} ] = [ \begin{matrix}0.5688 + 0.0164 i \\ 0.4260 - 0.0313 i\end{matrix} ]\end{matrix}$$

Data sub-carriers interpolations filters:

$$\begin{matrix}M = - 2 & M = - 1 \\ [ \begin{matrix}w [ 0 ] \\ w [ 1 ]\end{matrix} ] = [ \begin{matrix}0.4937 + 0.0070 i \\ 0.5018 - 0.0036 i\end{matrix} ] & [ \begin{matrix}w [ 0 ] \\ w [ 1 ]\end{matrix} ] = [ \begin{matrix}0.5018 + 0.0036 i \\ 0.4937 - 0.0070 i\end{matrix} ]\end{matrix}$$

The computation complexity is about 3 multiplications per sub-carrier.

The whole description given above is about how to estimate H.

Spectral filtering of H′ is similar to H as the autocorrelation function equals that of H, but correct values for the noise loading must be used.

The estimation of H and H′ on a per sub-carrier basis in the time domain may be added to the above-mentioned system. These estimates are or can be used in the system shown in FIG. 7, which shows an overview of the estimation and cancellation scheme according to the invention. First, an estimation of the channel transfer function Ĥ₀ is performed by dividing the received signal y₀ with the known pilot values αₚ at pilot positions. Next, the channel transfer function at virtual pilot position sub-carriers is estimated by a first H Wiener filter to obtain Ĥ₁, which is used for estimating the derivative of the channel transfer function \hat{H′} together with cleaned estimates from past OFDM symbols Ĥ₃. Pilot preremoval is performed from the received signal y₀ by using \hat{H′} and the known pilot values αₚ at pilot positions to get cleaned received signal y₁. Data \hat{α} is estimated from Ĥ₁ and y₁. ICI removal is performed by means of \hat{α}, Ĥ₁, and y₁ to obtain second cleaned signal y₂. The second cleaned signal y₂ is used for a second estimation of the channel transfer function at pilot positions by dividing the second cleaned signal y₂ with the pilot values αₚ to obtain a second estimate of the channel transfer function Ĥ₂ at pilot positions. Finally, a second Wiener filtering is performed to obtain the channel transfer function H₃ in all sub-carriers.

The input to the H estimation/improvement filter is the channel estimation H₁. It is an optional filter to be used on Ĥ₁ to improve its quality. FIG. 8 shows a schematic of the filter, where H^{k}(t) is the actual value of H at sub-carrier k for OFDM symbol t, Ĥ₁^{k}(t) is the noisy (noise+interference) estimation of H^{k}(t) after “1^{st} H Wiener Filters” and Ĥ_{3/2}^{k}(t) is the improved estimation with respect to Ĥ₁^{k}(t), of H^{k}(t) and n is the noise plus interference.

The H estimation filter is designed in the following way. The mean square error (MSE), ε, after the H estimation filter is defined as:
ε=E[|H^{k}(t)−Ĥ_{3/2}^{k}(t)|²]

Define:

$${\hat{H}}_{3 / 2}^{k} ( t ) = {\sum }_{l = - {M}_{1}}^{{M}_{2}} {w}_{l} {\hat{H}}_{1}^{k} ( t + l ) ( FIR filter )$$

It can be shown, (orthogonality principle), that ε is minimum if E└(H^{k}(t)−H_{3/2}^{k}(t))Ĥ₁^{k}*(p)┘=0 for every pε[t−M₁,t+M₂].

For convenience the sub-carrier index k will be dropped in the following derivations.

$$E ⌊ H ( t ) {\hat{H}}_{1}^{*} ( p ) ⌋ = E ⌊ {\hat{H}}_{3 / 2} ( t ) {\hat{H}}_{1}^{*} ( p ) ⌋$$

$$E [ H ( t ) {( H ( p ) + n ( p ) )}^{*} ] = E [ {\sum }_{l = - {M}_{1}}^{{M}_{2}} {w}_{l} {\hat{H}}_{1} ( t + l ) {\hat{H}}_{1}^{*} ( p ) ]$$

$$Assume H ( t ) and n ( p ) to be uncorrelated$$

$$E [ H ( t ) {H}^{*} ( p ) ] = {\sum }_{l = - {M}_{1}}^{{M}_{2}} {w}_{l} E [ ( H ( t + l ) + n ( t + l ) ) ( {H}^{*} ( p ) + {n}^{*} ( p ) ) ]$$

$$E [ H ( t ) {H}^{*} ( p ) ] = {\sum }_{l = - {M}_{1}}^{{M}_{2}} {w}_{l} ( E [ H ( t + l ) {H}^{*} ( p ) ] + E [ n ( t + l ) {n}^{*} ( p ) ] )$$

Assume the noise and interference to be white, therefore E[n(t+l)n*(p)]=0, unless t+l=p. Writing the equations in matrix form

$$[ \begin{matrix}{R}_{HH} ( - {M}_{1} ) \\ ⋯ \\ {R}_{HH} ( {M}_{2} )\end{matrix} ] = [ \begin{matrix}[ \begin{matrix}{R}_{HH} ( 0 ) & ⋯ & {R}_{HH} ( {M}_{1} + {M}_{2} ) \\ ⋯ & ⋯ & ⋯ \\ {R}_{HH} ( - {M}_{1} - {M}_{2} ) & ⋯ & {R}_{HH} ( 0 )\end{matrix} ] + \\ [ \begin{matrix}{R}_{nn} ( 0 ) & & \\ & ⋯ & \\ & & {R}_{nn} ( 0 )\end{matrix} ]\end{matrix} ] \cdot [ \begin{matrix}{w}_{- {M}_{1}} \\ ⋯ \\ {w}_{{M}_{2}}\end{matrix} ]$$

$$Solving for w \text{:} \\ [ \begin{matrix}{w}_{- {M}_{1}} \\ ⋯ \\ {w}_{{M}_{2}}\end{matrix} ] = {[ \begin{matrix}[ \begin{matrix}{R}_{HH} ( 0 ) & ⋯ & {R}_{HH} ( {M}_{1} + {M}_{2} ) \\ ⋯ & ⋯ & ⋯ \\ {R}_{HH} ( - {M}_{1} - {M}_{2} ) & ⋯ & {R}_{HH} ( 0 )\end{matrix} ] + \\ [ \begin{matrix}{R}_{nn} ( 0 ) & & \\ & ⋯ & \\ & & {R}_{nn} ( 0 )\end{matrix} ]\end{matrix} ]}^{- 1} \cdot [ \begin{matrix}{R}_{HH} ( - {M}_{1} ) \\ ⋮ \\ {R}_{HH} ( {M}_{2} )\end{matrix} ]$$

can be shown that R_{HH}(τ)=J₀(2πf_{d,max}τ), where J₀(t) is the zero order Bessel function and Rₙₙ(0) is the noise+interference power.

For getting the most improved estimate of H the best possible input estimates of H should be used.

For example: Estimating H(t=10) on a sub-carrier, k, using a filter as described above with parameters M2=0 and M1=−9. In simulations it is shown that the MSE of H₁ is about −27 dB and the MSE of H₃ is about −36 dB.

In order to calculate Ĥ_{3/2}(10) the values Ĥ₁(1), . . . , Ĥ₁(10) are needed. However, since Ĥ₃(1), . . . , Ĥ₃(10) are also available and have a better quality they are used. In the filter design this difference in quality is taken into account in the noise+interference power part, Rₙₙ. Designing the filter for these parameters and f_{d,max} of 112 Hz and T_{OFDM} (time between consecutive OFDM symbols of) 0.001 s yields:

$$[ \begin{matrix}{w}_{0} \\ {w}_{- 1} \\ {w}_{- 2} \\ {w}_{- 3} \\ {w}_{- 4} \\ {w}_{- 5} \\ {w}_{- 6} \\ {w}_{- 7} \\ {w}_{- 8} \\ {w}_{- 9}\end{matrix} ] = [ \begin{matrix}0.6380 \\ 0.8414 \\ - 0.4828 \\ - 0.2726 \\ 0.1726 \\ 0.2223 \\ - 0.0257 \\ - 0.1571 \\ 0.0006 \\ 0.0539\end{matrix} ]$$

The MSE of this estimate is about −29 dB. Note that the quality of H₃ also depends on the improvement realized by this H estimation filter. The improvement from −27 dB to −29 dB is not large. Therefore the improvement of the quality of the estimation of H by this filter seems not to justify its complexity. However calculating the filter for the same parameters only changing the f_{d,max} from 112 Hz to 11.2 Hz results in a MSE of −36 dB. This gain does justify the additional complexity, so estimation of H in time is only reasonable for low values of f_{d,max}.

Estimates of H may be made only on a subset of all the sub-carriers, for example the possible pilot position.

The total complexity of the H estimate will be reduced using the interpolators instead of doing H estimation on every sub-carrier if the filter length of the H filter is longer than 2.

The filter below is used to estimate H′ based on estimates of H. Schematically this filter is shown in FIG. 9, where: H^{k}(t) is the actual value of H at sub-carrier k for OFDM symbol t, Ĥ₁^{k}(t) is the noisy estimation of H^{k}(t) after “1^{st} H Wiener Filters”, H^{k}′(t) is the actual value H′ at sub-carrier k for OFDM symbol t, Ĥ^{k}′(t) is the estimated value of H′ at sub-carrier k for OFDM symbol t.

The mean square error (MSE), ε, after the H′ estimation filter is defined as:
ε=E[|H^{k}′(t)−Ĥ^{k}′(t)|²]

Define:

$${\hat{H}}^{{k}^{′}} ( t ) = {\sum }_{l = - {M}_{1}}^{{M}_{2}} {w}_{l} {\hat{H}}_{1}^{k} ( t + l ) ( FIR filter )$$

Using the orthogonality principle to obtain the minimum MSE.
E└(H^{k}′(t))Ĥ₁^{k}*(p)┘=0 for every pε[t−M₁,t+M₂].

For convenience the sub-carrier index k will be dropped in the following derivations.

$$E ⌊ {H}^{′} ( t ) {\hat{H}}_{1}^{*} ( p ) ⌋ = E ⌊ {\hat{H}}^{′} ( t ) {\hat{H}}_{1}^{*} ( p ) ⌋$$

$$E [ {H}^{′} ( t ) {( H ( p ) + n ( p ) )}^{*} ] = E [ {\sum }_{l = - {M}_{1}}^{{M}_{2}} {w}_{l} {\hat{H}}_{1} ( t + l ) {\hat{H}}_{1}^{*} ( p ) ]$$

$$Assume H ( t ) and n ( p ) to be uncorrelated$$

$$E [ {H}^{′} ( t ) {H}^{*} ( p ) ] = {\sum }_{l = - {M}_{1}}^{{M}_{2}} {w}_{l} E [ ( H ( t + l ) + n ( t + l ) ) ( {H}^{*} ( p ) + {n}^{*} ( p ) ) ]$$

$$E [ {H}^{′} ( t ) {H}^{*} ( p ) ] = {\sum }_{l = - {M}_{1}}^{{M}_{2}} {w}_{l} ( E [ H ( t + l ) {H}^{*} ( p ) ] + E [ n ( t + l ) {n}^{*} ( p ) ] )$$

Assume the noise to be white, therefore E[n(t+l)n*(p)]=0, unless t+l=p.

Writing the equations in matrix form

$$[ \begin{matrix}{R}_{{H}^{′} H} ( {M}_{1} ) \\ ⋯ \\ {R}_{{H}^{′} H} ( - {M}_{2} )\end{matrix} ] = [ \begin{matrix}[ \begin{matrix}{R}_{HH} ( 0 ) & ⋯ & {R}_{HH} ( {M}_{1} + {M}_{2} ) \\ ⋯ & ⋯ & ⋯ \\ {R}_{HH} ( - {M}_{1} - {M}_{2} ) & ⋯ & {R}_{HH} ( 0 )\end{matrix} ] + \\ [ \begin{matrix}{R}_{nn} ( 0 ) & & \\ & ⋯ & \\ & & {R}_{nn} ( 0 )\end{matrix} ]\end{matrix} ] \cdot [ \begin{matrix}{w}_{- {M}_{1}} \\ ⋯ \\ {w}_{{M}_{2}}\end{matrix} ]$$

can be shown that R_{H′H}(τ)=−2πf_{d,max}J₁(2πf_{d,max}τ). Where J₁(t) is the first order Bessel function.

For getting the best estimate of H′ the best possible estimates of H should be used.

For example: Estimating H′(t=10) on a sub-carrier, k, using a filter as described above with parameters M2=0 and M1=−9. In order to calculate Ĥ_{3/2}(10) the values Ĥ₁(1), . . . , Ĥ₁(10) are needed. However, since Ĥ₃(1), . . . , Ĥ₃(10) are also available and have a better quality they are used.

In the filter design this difference in quality is taken into account in the noise+interference power part, Rₙₙ. Designing the filter for these parameters and f_{d,max} of 112 Hz and T_{OFDM} (time between consecutive OFDM symbols of) 0.001 s yields:

$$[ \begin{matrix}{w}_{0} \\ {w}_{- 1} \\ {w}_{- 2} \\ {w}_{- 3} \\ {w}_{- 4} \\ {w}_{- 5} \\ {w}_{- 6} \\ {w}_{- 7} \\ {w}_{- 8} \\ {w}_{- 9}\end{matrix} ] = {10}^{3} * [ \begin{matrix}0.7457 \\ - 0.0940 \\ - 1.0751 \\ - 0.0985 \\ 0.5663 \\ 0.2850 \\ - 0.2838 \\ - 0.2922 \\ 0.2213 \\ 0.0039\end{matrix} ]$$

Simulations show a MSE error of about −21 dB for the given set of parameters.

Estimates on H′ will be made only on a subset of all the sub-carriers, for example the possible pilots position. The total complexity of the H′ estimate will be reduced using the interpolators in stead of doing H′ estimation on every sub-carrier if the filter length of the H′ filter is longer than 2.

If a delay is allowed in the estimation of H′ meaning that M₂>0. The quality of the H′ estimation can be improved considerably or kept the same with a shorter filter. A disadvantage is that for example, M₁=4, M₂=2, estimating Ĥ′ (8) requires Ĥ₁(4), . . . , Ĥ₁(10), causing a delay in reception and requires buffering.

The temporal filters are real. The spectral filters can also be real by a proper cyclic permutation of the time samples at the input of the FFT.

The different filters and operations may be performed by a dedicated digital signal processor (DSP) and in software. Alternatively, all or part of the method steps may be performed in hardware or combinations of hardware and software, such as ASIC:s (Application Specific Integrated Circuit), PGA (Programmable Gate Array), etc.

It is mentioned that the expression “comprising” does not exclude other elements or steps and that “a” or “an” does not exclude a plurality of elements. Moreover, reference signs in the claims shall not be construed as limiting the scope of the claims.

Herein above has been described several embodiments of the invention with reference to the drawings. A skilled person reading this description will contemplate several other alternatives and such alternatives are intended to be within the scope of the invention. Also other combinations than those specifically mentioned herein are intended to be within the scope of the invention. The invention is only limited by the appended patent claims.

1. A method of processing OFDM encoded digital signals, wherein said OFDM encoded digital signals are transmitted as data symbol sub-carriers in several frequency channels, a subset of said sub-carriers being in the form of pilot sub-carriers having a known value to the receiver, comprising:
first estimation of channel coefficients (H₀) at said pilot sub-carriers;
cleaning said estimated channel coefficients (H₀) at said pilot sub-carriers;
estimating the temporal derivative of the channel coefficients (H′) by temporal Wiener filtering;
second estimation of channel coefficients (H₁) at said data symbol sub-carriers.

2. The method of claim 1, wherein said first estimation is performed by dividing received symbols (yₚ) at said pilot sub-carriers by the known pilot symbols (aₚ).

3. The method of claim 1, wherein said cleaning is performed by a Wiener filter.

4. The method of claim 1, further comprising before said second estimation:
third estimation of channel coefficients at possible pilot sub-carriers in between said pilot sub-carriers.

5. The method of claim 1, wherein said second or third estimation comprises interpolation.

6. The method of claim 5, wherein said interpolation is performed in a frequency direction, for example by using a Wiener filter, specifically a 2-tap Wiener filter.

7. The method of claim 6, further comprising interpolation performed in a time direction using multiple OFDM symbols, for example by using a Wiener filter.

8. The method of claim 5, wherein said interpolation is performed in a time direction, for example by using a Wiener filter.

9. The method of claim 8, further comprising interpolation in a frequency direction, for example by using a Wiener filter.

10. The method of claim 1, wherein said Wiener filtering is performed by using a finite impulse transfer function (FIR) filter having pre-computed filter coefficients.

11. The method of claim 1, wherein said Wiener filter is a filter having a predetermined length (n) and with an actual observation value (M), which is an off-center value, for example −7 or −3 for an 11-tap filter.

12. The method of claim 11, wherein said predetermined length (n) of the filter is 9, 11, 13, 23, 25 or 27.

13. The method of claim 11, wherein said actual observation value (M) is varied from −5 to −10 at a left edge of the OFDM symbol and varied from 0 to −5 at a right edge of the OFDM symbol for performing edge filtering.

14. The method of claim 1, further comprising
cleaning said first estimation of channel coefficients (H₀) at said pilot sub-carriers by a temporal Wiener filtering.

15. The method of claim 14, wherein said cleaning is made on a subset of the sub-carriers, for example at pilot positions.

16. The method of claim 15, wherein said cleaning is performed by a FIR filter.

17. A signal processor arranged to process received OFDM encoded digital signals, wherein said OFDM encoded digital signals are transmitted as data symbol sub-carriers in several frequency channels, a subset of said sub-carriers being pilot sub-carriers having a value known to the receiver, comprising:
a first processor arranged to carry out a first estimation of channel coefficients H₀ at said pilot sub-carriers;
a cleaner arranged to clean said estimated channel coefficients H₀ at said pilot sub-carriers;
a second processor arranged to carry out a second estimation of channel coefficients H₁ at said data symbol sub-carriers.

18. A receiver arranged to receive OFDM encoded digital signals, wherein said OFDM encoded digital signals are transmitted as data symbol sub-carriers in several frequency channels, a subset of said sub-carriers being pilot sub-carriers that have a value known to the receiver comprising:
a first processor arranged to carry out a first estimation of channel coefficients H₀ at said pilot sub-carriers;
a cleaner arranged to clean said estimated channel coefficients H₀ at said pilot sub-carriers;
a second processor arranged to carry out a second estimation of channel coefficients H₁ at said data symbol sub-carriers.

19. A mobile device arranged to receive OFDM encoded digital signals that are transmitted as data symbol sub-carriers in several frequency channels, a subset of said sub-carriers being pilot sub-carrier having a known value to the receiver, wherein the mobile device comprises:
a first processor arranged to carry out a first estimation of channel coefficients H₀ at said pilot sub-carriers;
a cleaner arranged to clean said estimated channel coefficients H₀ at said pilot sub-carriers;
a second processor arranged to carry out a second estimation of channel coefficients H₁ at said data symbol sub-carriers.

20. A mobile device arranged to receive OFDM encoded digital signals that are transmitted as data symbol sub-carriers in several frequency channels, a subset of said sub-carriers being pilot sub-carrier having a known value to the receiver, wherein the mobile device is arranged to carry out the method according to claim 1.

21. Telecommunication system comprising a mobile device according to claim 20.
